(19) United States
(12) Patent Application Publication
(10) Pub. No.: US 2025/0222657 A1
(43) Pub. Date: Jul. 10, 2025

(54) 3D PRINTING WITH OPTIMIZATION OF PRINT SETTINGS

(71) Applicant: Markforged, Inc., Waltham, MA (US)

(72) Inventors: Brady Adams, Sudbury, MA (US); Bruce David Jones, Sudbury, MA (US)

(21) Appl. No.: 19/013,364

(22) Filed: Jan. 8, 2025

Related U.S. Application Data
(60) Provisional application No. 63/618,956, filed on Jan. 9, 2024.

(51) Int. Cl. B29C 64/393; B33Y 10/00; B33Y 30/00; B33Y 50/02

(52) U.S. Cl. CPC B29C 64/393; B33Y 10/00; B33Y 30/00; B33Y 50/02

(57) ABSTRACT

A 3D printing apparatus and method determines one or more optimized 3D print settings for printing a part. The determination may be performed despite having limited or no information regarding a user's intended use of the part. The determination may include computing a stiffness matrix, and computing eigenvectors and/or eigenvalues and determining a lowest energy mode. The determination may further include computing an internal mechanical state of the part based on applying various print settings, to determine an optimal print setting.

### CROSS-REFERENCE TO RELATED APPLICATION

This application claims the benefit under 35 U.S.C. § 119(e) of U.S. Provisional Patent Application No. 63/618,956, filed Jan. 9, 2024, and titled “3D PRINTING WITH OPTIMIZATION OF PRINT SETTINGS,” the entirety of which is incorporated herein by reference.

### FIELD OF THE INVENTION

The invention relates to an apparatus and method for 3D printing with optimizing a 3D print setting when little or no information regarding the intended use of a 3D part to be printed is available.

### BACKGROUND OF THE INVENTION

In a 3D printing environment, 3D parts may have certain desired mechanical properties, based on the particular application scenario in which the part is intended for use. For example, stiffness in a particular direction may yield improved performance based on the intended use of a part, such as resistance to deformation. Likewise, strength in a particular direction may yield improved performance based on the intended use of the part, based on the stress intensities and directions that the part is anticipated to undergo during its use.

Such information regarding the intended use of a part may be input by a user during a 3D printing operation, and may result in adjustment of configuration settings for a 3D printing operation to optimize the mechanical properties of the part. For example, orientation, in-fill pattern, reinforcement, etc., may be configured to provide the desired mechanical properties. In such a situation, such optimization of mechanical properties may require that a user provide, in addition to the dimensional parameters of the part, additional information concerning the intended use of the part. However, such additional information may not always be available.

Therefore, a need exists to provide optimization of 3D print settings to achieve optimal mechanical properties in the 3D part without necessitating information as to how the 3D part may be used.

### SUMMARY OF THE INVENTION

One aspect of the present invention relates to an apparatus comprising at least one processor; and at least one memory, wherein the at least one memory stores computer-readable instructions which, when executed by the at least one processor, cause the processor to: receive design data corresponding to an object; compute, based on the received design data, stiffness information of the object; determine a fundamental deformation shape, based on the stiffness information; and determine a 3D print setting for printing the object, based on the determined fundamental deformation shape.

Another aspect of the present invention relates to a method comprising receiving design data corresponding to an object; computing, based on the received design data, stiffness information of the object; determining a fundamental deformation shape, based on the stiffness information; and determining a 3D print setting for printing the object, based on the determined fundamental deformation shape.

These and other aspects of the invention will become apparent from the following disclosure.

### BRIEF DESCRIPTION OF THE DRAWINGS

FIGS. 1A and 1B illustrate an apparatus, in accordance with one embodiment.

FIG. 2 is a flow chart for an operation for optimizing 3D print settings for printing a part, in accordance with one embodiment.

FIG. 3A illustrates an example of a 3D part to be printed, and FIG. 3B illustrates an example of a mesh of the part geometry generated for the 3D part of FIG. 3A, in accordance with one embodiment.

FIGS. 4A-4C illustrate examples of computed eigenmode shapes corresponding to the example 3D part of FIG. 3A, in accordance with one embodiment.

FIG. 5A illustrates another example of a 3D part to be printed, and FIGS. 5B-5C illustrate examples of generated meshes and computed eigenmode shapes corresponding to the example 3D part of FIG. 5A, in accordance with one embodiment.

FIG. 6 is a flow chart for an operation for optimizing 3D print settings for printing a part, in accordance with one embodiment.

FIG. 7A illustrates an example of a 3D part to be printed and boundary information for the 3D part, and FIGS. 7B-7D illustrate examples of generated meshes and computed eigenmode shapes corresponding to the example 3D part of FIG. 7A, in accordance with one embodiment.

### DETAILED DESCRIPTION OF THE PREFERRED EMBODIMENTS

The present invention relates to an apparatus and method of optimizing 3D print settings for printing a part. The present invention performs such optimization having limited or no information regarding the user's intended use of the 3D part.

### 3D Printer Apparatus

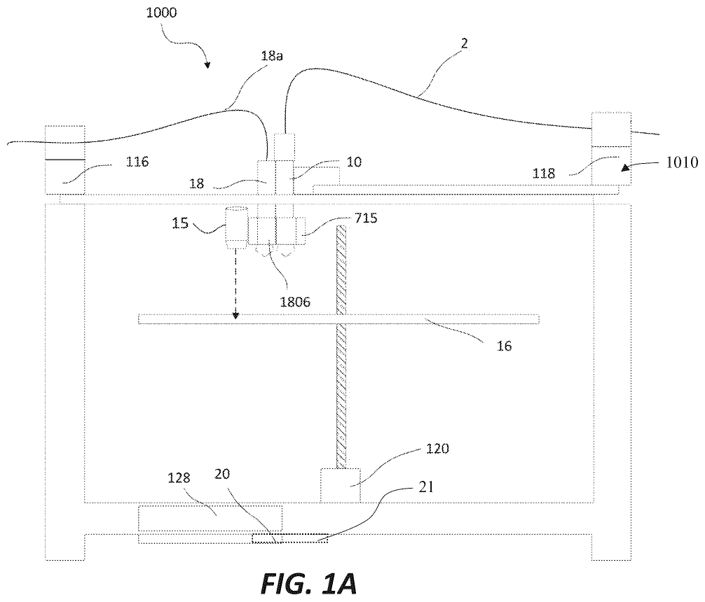

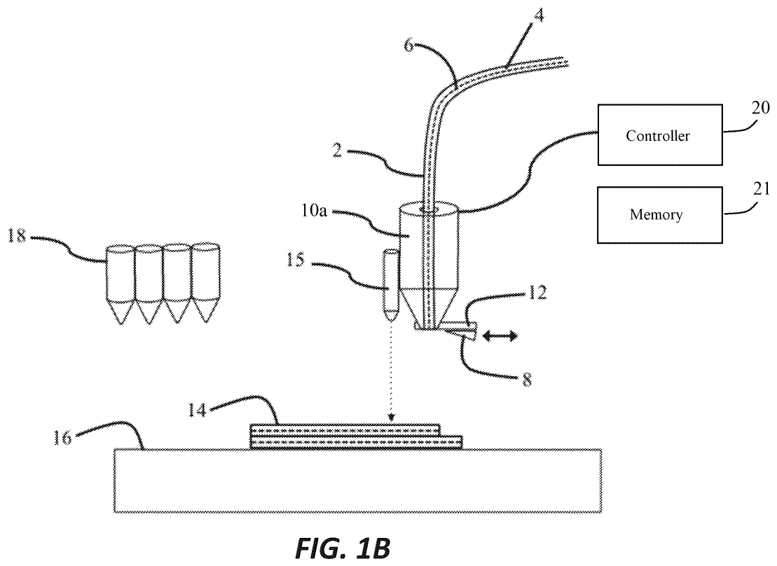

FIGS. 1A-1B illustrate an apparatus 1000 in accordance with one embodiment of the invention. The apparatus 1000 includes one or more controllers 20, one or more memories 21, and one or more print heads 10, 18. For instance, one head 10 may deposit a metal or fiber reinforced composite filament 2, and another head 18 may apply pure or neat matrix resin 18a (thermoplastic or curing), which may include, but is not limited to, a polymer or curable monomer and/or a polymer or curable monomer filled, e.g., with chopped carbon fiber, carbon black, silica, and/or aramid fiber. In the case of the filament 2 being a fiber reinforced composite filament, such filament (also referred to herein as continuous core reinforced filament) may be substantially void free and include a polymer or resin that coats, permeates or impregnates an internal continuous core (including, but not limited to, single, multi-strand, or multi-material). It should be noted that although the print head 18 is shown as an extrusion print head, “fill material print head” 18 as used herein includes optical or UV curing, heat fusion or sintering, or “polyjet”, liquid, colloid, suspension or powder jetting devices (not shown) for depositing fill material. It will also be appreciated that a material bead formed by the filament 2 may be deposited as extruded thermoplastic or metal, deposited as continuous or semi-continuous fiber, solidified as photo or UV cured resin, or jetted as metal or binders mixed with plastics or metal, or are structural, functional or coatings. The fiber reinforced composite filament 2 (also referred to herein as continuous core reinforced filament) may be a push-pulpreg that is substantially void free and includes a polymer or resin 4 that coats or impregnates an internal continuous single core or multistrand core 6. The apparatus includes heaters 715, 1806 to heat the print heads 10, 18, respectively so as to facilitate deposition of layers of material to form the object 14 to be printed. A cutter 8 controlled by the controller 20 may cut the filament 2 during the deposition process in order to (i) form separate features and components on the structure as well as (ii) control the directionality or anisotropy of the deposited material and/or bonded ranks in multiple sections and layers. As depicted, the cutter 8 is a cutting blade associated with a backing plate 12 located at the nozzle outlet. Other cutters include laser, high-pressure air or fluid, or shears. The apparatus 1000 may also include additional non-printing tool heads, such as for milling, SLS, etc. The apparatus 1000 may also include a touch screen display panel 128 to provide user feedback and accept inputs, commands, and control parameters from the user.

The apparatus 1000 includes a gantry 1010 that supports the print heads 10, 18. The gantry 1010 includes motors 116, 118 to move the print heads 10, 18 along X and Y rails in the X and Y directions, respectively. The apparatus 1000 also includes a build platen 16 (e.g., print bed) on which an object to be printed is formed. The height of the build platen 16 is controlled by a motor 120 for Z direction adjustment. Although the movement of the apparatus has been described based on a Cartesian arrangement for relatively moving the print heads in three orthogonal translation directions, other arrangements are considered within the scope of, and expressly described by, a drive system or drive or motorized drive that may relatively move a print head and a build plate supporting a 3D printed object in at least three degrees of freedom (i.e., in four or more degrees of freedom as well). For example, for three degrees of freedom, a delta, parallel robot structure may use three parallelogram arms connected to universal joints at the base, optionally to maintain an orientation of the print head (e.g., three motorized degrees of freedom among the print head and build plate) or to change the orientation of the print head (e.g., four or higher degrees of freedom among the print head and build plate). As another example, the print head may be mounted on a robotic arm having three, four, five, six, or higher degrees of freedom; and/or the build platform may rotate, translate in three dimensions, or be spun.

FIG. 1B depicts an embodiment of the apparatus 1000 applying the filament 2 to build a structure. In one embodiment, the filament 2 is a metal filament for printing a metal object. In one embodiment, the filament 2 is a fiber reinforced composite filament (also referred to herein as continuous core reinforced filament) may be a push-pulpreg that is substantially void free and includes a polymer or resin 4 that coats or impregnates an internal continuous single core or multistrand core 6. In one embodiment, the filament 2 is an unreinforced filament.

The filament 2 is fed through a nozzle 10a disposed at the end of the print head 10, and heated to extrude the filament material for printing. In the case that the filament 2 is a fiber reinforced composite filament, the filament 2 is heated to a controlled push-pultrusion temperature selected for the matrix material to maintain a predetermined viscosity, and/or a predetermined amount force of adhesion of bonded ranks, and/or a surface finish. The push-pultrusion may be greater than the melting temperature of the polymer 4, less than a decomposition temperature of the polymer 4 and less than either the melting or decomposition temperature of the core 6.

After being heated in the nozzle 10a and having its material substantially melted, the filament 2 is applied onto the build platen 16 to build successive layers 14 to form a three dimensional structure. One or both of (i) the position and orientation of the build platen 16 or (ii) the position and orientation of the nozzle 10a are controlled by a controller 20 to deposit the filament 2 in the desired location and direction. Position and orientation control mechanisms include gantry systems, robotic arms, and/or H frames, any of these equipped with position and/or displacement sensors to the controller 20 to monitor the relative position or velocity of nozzle 10a relative to the build platen 16 and/or the layers 14 of the object being constructed. The controller 20 may use sensed X, Y, and/or Z positions and/or displacement or velocity vectors to control subsequent movements of the nozzle 10a or platen 16. The apparatus 1000 may optionally include a laser scanner 15 to measure distance to the platen 16 or the layer 14, displacement transducers in any of three translation and/or three rotation axes, distance integrators, and/or accelerometers detecting a position or movement of the nozzle 10a to the build platen 16. The laser scanner 15 may scan the section ahead of the nozzle 10a in order to correct the Z height of the nozzle 10a, or the fill volume required, to match a desired deposition profile. This measurement may also be used to fill in voids detected in the object. The laser scanner 15 may also measure the object after the filament is applied to confirm the depth and position of the deposited bonded ranks. Distance from a lip of the deposition head to the previous layer or build platen, or the height of a bonded rank may be confirmed using an appropriate sensor.

Various 3D-printing aspects of the apparatus 1000 are described in detail in U.S. Patent Application Publication No. 2019/0009472, which is incorporated by reference herein in its entirety.

### Operation for Optimizing 3D Print Settings

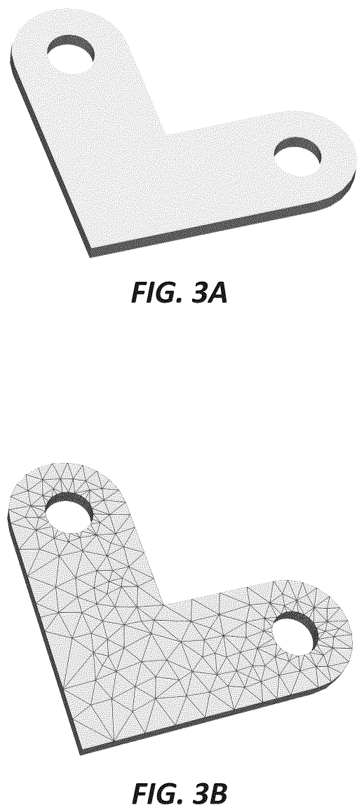

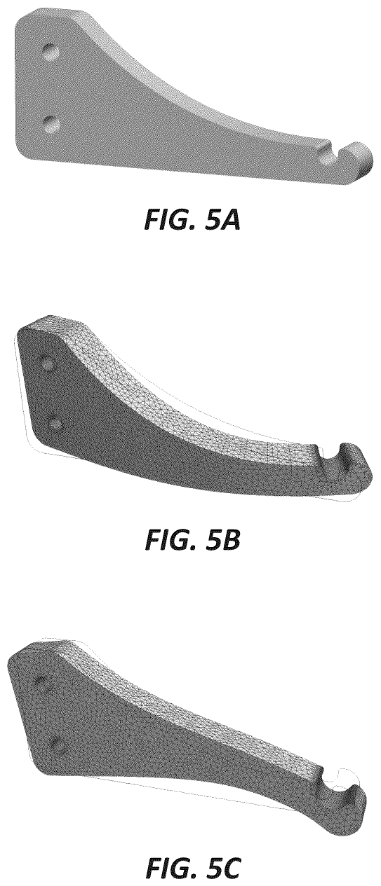

Various operations will be described herein with reference to two example 3D parts to be printed. FIG. 3A illustrates a first example 3D part, which is generally flat in one direction and L-shaped in the other two directions, and which include holes at each L-shaped end. FIG. 5A illustrates a second example 3D part, which is generally flat in one direction and tapered in the other two directions, and which includes two holes at the larger end of the taper and a depression in the smaller end of the taper.

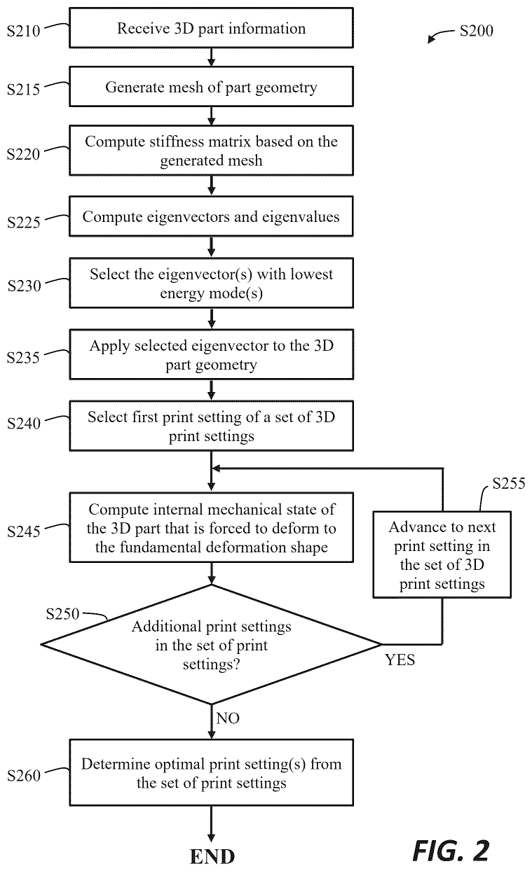

FIG. 2 illustrates an operation S200 for optimizing 3D print settings for printing a part. In one aspect of the present invention, the optimization of print settings is performed having limited or no information regarding the user's intended use of the 3D part.

In step S210, the controller 20 receives 3D part information of a 3D part to be printed. In one embodiment, the controller 20 receives the part geometry over a wired or wireless network (e.g., Ethernet or WiFi), such as an internal network or the Internet. In one embodiment, the controller 20 receives the part geometry via a wired or wireless data connection (not shown) between the controller 20 and another computing platform, such as USB or Bluetooth. In one embodiment, the controller 20 receives a 3D CAD or other design file. As one example, the 3D part may be the part illustrated in FIG. 3A, and the 3D part information may be part geometry information corresponding to such part. As another example, the 3D part may be the part illustrated in FIG. 5A, and the 3D part information may be part geometry information corresponding to such part.

In step S215, the controller 20 generates a mesh of the part geometry corresponding to the 3D part, based on the 3D part information received in step S210. The generated mesh may include, for example, a volumetric finite element mesh. FIG. 3B illustrates an example part geometry mesh of the example part illustrated in FIG. 3A. Any known approach to generating a finite element mesh may be used in connection with the present invention including, for example, the approaches described in Daniel S. H. Lo, FINITE ELEMENT MESH GENERATION (2015), which is incorporated by reference herein in its entirety.

In step S220, the controller 20 computes a stiffness matrix based on the mesh generated in step S215. Any known approach to generating a stiffness matrix may be used in connection with the present invention. In one embodiment, the controller 20 computes the stiffness matrix using an approach described in Cook, R. D., Malkus, D. S., & Plesha, M. E., CONCEPTS AND APPLICATIONS OF FINITE ELEMENT ANALYSIS (1989), which is incorporated by reference herein its entirety. In one embodiment, the computing of the stiffness matrix may involve assuming that the 3D part is produced using a homogeneous material. In one embodiment, the computation of the stiffness matrix does not consider the specifics of the 3D-printed part. For example, the controller 20 may perform the computation by assuming the geometry is homogeneously composed of aluminum material. It will be appreciated that one purpose of step S220 may be to establish a shape to be subsequently used for performing relative comparisons of different 3D print settings.

In step S225, the controller 20 computes eigenvectors and/or eigenvalues of the stiffness matrix computed in step S220. The eigenvectors and/or eigenvalues may collectively be referred to as “eigenmodes”. The computed eigenmodes may reveal information as to which portion of the 3D part is likely most susceptible to deformation.

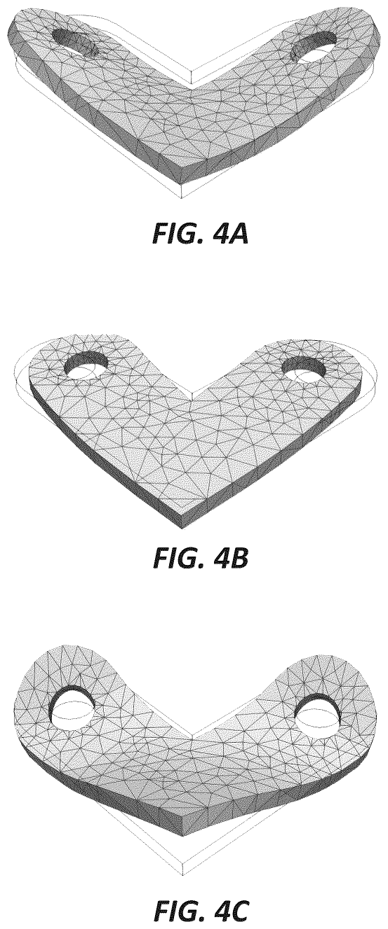

As an example, the controller 20 may compute the eigenmodes using an approach described in Thomas J. R. Hughes, THE FINITE ELEMENT METHOD: LINEAR STATIC AND DYNAMIC FINITE ELEMENT ANALYSIS (2000), which is incorporated by reference herein in its entirety. FIGS. 4A-4C illustrates examples of computed eigenmode shapes corresponding to the first example part illustrated in FIG. 3A, while FIGS. 5B-5C illustrate examples of computed eigenmode shapes corresponding to the second example part illustrated in FIG. 5A (along with the mesh geometries generated in step S215). Each of these figures also depicts an outline of the original 3D part shape, to further illustrate the difference between the eigenmode shape and the original shape.

In step S230, the controller 20 selects the eigenmode(s) corresponding to the “lowest energy mode(s).” The “lowest energy mode” is associated with the deformed shape that can be produced with the least amount of elastic strain energy (e.g., work). “Elastic strain energy” is the energy stored in the 3D part as a response to external work being performed. In essence, the lowest energy mode is the eigenmode under which the least amount of applied strain energy results in deformation. The lowest energy mode corresponds to the eigenmodes containing the lowest, non-zero, eigenvalues.

In one embodiment, the controller 20 selects the lowest energy mode by employing a criteria that selects the eigenvector(s) having the lowest non-zero eigenvalue. However, other approaches may be utilized in accordance with the invention that may not necessarily involve selecting the single lowest energy mode. For example, the controller 20 may select a combination of a certain plural number of the lowest energy modes (e.g., as one example, a combination of the ten lowest energy modes). In one embodiment, the controller 20 may employ a neural network to select the eigenvector(s).

In step S235, the controller 20 applies the selected eigenvector from step S230 to the 3D part geometry. The selected eigenvector may also be referred to as the “fundamental deformation shape” and represents the shape that will be used for the relative comparisons of different 3D print settings.

In step S240, the controller 20 selects a first print setting out of a set of 3D print settings. The set of 3D print settings may encompass the gamut of potential print settings that could be used in printing the 3D part. For example, the print settings may include one or more (or all) of infill density, infill direction, application of reinforcement (e.g., fiber reinforcement), shell thickness (e.g., number of contour shells and/or number of solid layers on bottom and top), layer height, part orientation on build platen, etc. Of course, it will be appreciated that print settings are not limited to the foregoing, and that the present invention is applicable to any print setting that potentially has a physical influence on the final printed 3D part.

In step S245, the controller 20 computes an internal mechanical state of the 3D part having forced to deform to the fundamental deformation shape, in the circumstance where the print setting selected in step S240 is utilized. In one embodiment, the controller 20 employs a finite element method (FEM) for such computation. In particular, FEM performs a simulation regarding the mechanical behavior of objects, whereby the stiffness matrix multiplied by the deformation displacement indicates the forces applied to portions of the 3D part.

As one example, the computation in step S245 may reveal strength information regarding the 3D part. That is, if the 3D part is forced into the fundamental deformation shape, the computed internal mechanical state indicates how stiff and strong the 3D part is. Such computed information in turn may be used as parameters for determining appropriate selections on print material or print settings. This computation in step S245 may include calculating an internal strain energy of the part. For example, if a portion of the 3D part has been reinforced with fiber (e.g., based on the print setting), the computed internal mechanical state may reveal that such reinforced portion may require significantly more energy to be transformed into a deformed state.

In step S250, the controller 20 determines whether there are additional print settings in the set of print settings. If there are additional print settings, the operation proceeds to step S255. If there are no more print settings, the operation proceeds to step S260.

In S255, the operation advances to the next print setting in the set of 3D print settings, so that the computation in step S245 can be repeated based on the next print setting. It will be appreciated that the set of 3D print settings may encompass any number of print settings, including tens, hundreds, or even thousands of different print settings. After advancing to the next print setting, the operation returns to step S245.

In step S260, the controller 20 determines and selects one or more optimal print settings from the set of print settings. It will be appreciated that various criteria may be employed to make such determination and selection. In one embodiment, the controller 20 determines the optimal print setting(s) based on one or more of:
1. The print setting(s) which yield the lowest simulated stresses
2. The print setting(s) which yield the highest simulated strengths
3. The print setting(s) which yield the highest simulated aggregate elastic strain energy
4. A combination of #1-3
5. A combination of #1-4 which also considers required print time
6. A combination of #1-4 which also considers required part/material cost
7. A combination of all of the above
8. The print setting(s) which yield behavior closest to that of a target material (e.g., aluminum)

In one embodiment, the controller 20 may determine and select optimal print setting(s) by presenting some (e.g., the highest-ranked) or all of print setting options to the user and deferring to the user to select the desired print setting(s). Such presentation to the user may include, as non-limiting examples:
annotating each print setting option,
displaying the “cost” for each option in terms of strain/strength, time, material, etc.,
displaying an ordered list or sets of recommended print settings based on the user's priorities

It will be appreciated that while the user may provide some input at this stage in deciding the final print settings, the present invention is generally focused on the scenarios where little or no information regarding the use case of the 3D part was known in advance or was provided (e.g., by the user).

The present invention also includes other embodiments beyond the ones described above. In one embodiment, the stiffness matrix computed in step S220 may determine the fundamental deformation shape using only nodes on the external surface of the geometry by condensing out the internal nodes. This may be performed by extrapolating information from the internal nodes to the nodes on the 3D part surface. Such approach is also referred to as “Guyan reduction” or “static condensation.” In particular, the part geometry mesh may include “nodes” between elements. Instead of including the internal nodes as part of the stiffness matrix computation process (which makes the computation more mathematically straightforward but involves simulating force applied in middle of the 3D part), the stiffness matrix may be computed by condensing out the internal nodes. Such approach may be more computationally expensive, but may also provide improved accuracy and better results. Such approach also provides the benefit of allowing the internal nodes to freely deform.

In one embodiment, step S230 may involve selecting a combination of modes beyond solely the lowest energy mode. In one embodiment, step S230 may involve a combination of modes. In one embodiment, step S230 may involve presenting multiple modes to the user and receiving user input as to the mode(s) that the user believes are most applicable to the user's use case for the 3D part.

In one embodiment, step S260 may involve determining and selecting one or more print settings that may not be optimal for one individual mode from step S230 but may be reasonably sufficient across multiple modes.

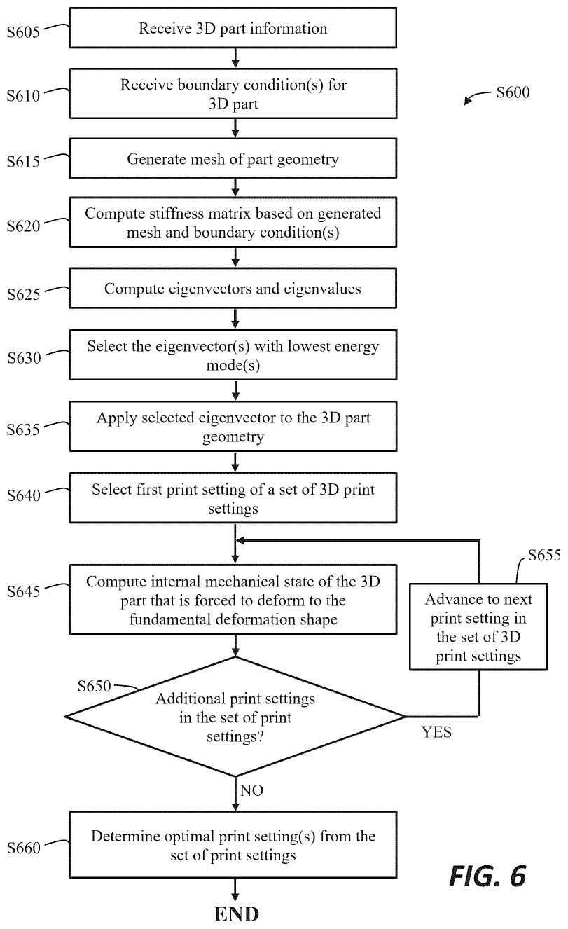

FIG. 6 illustrates an operation S600 for optimizing 3D print settings for printing a part while having limited or no information regarding the user's intended use of the 3D part. Operation S600 differs from operation S200 in receiving limited use case information (e.g., boundary condition(s)) for the 3D part, and utilizing that information in determining optimal print settings.

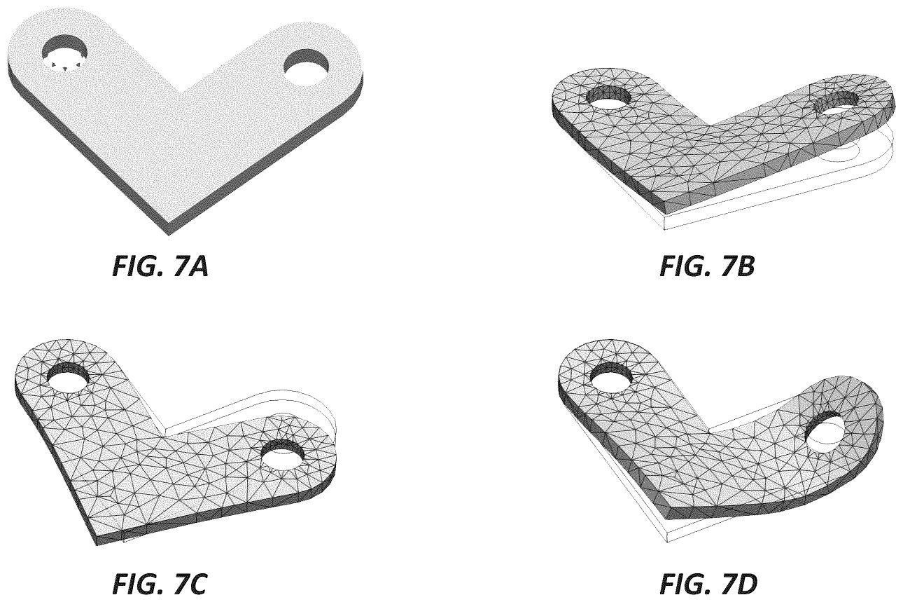

In step S605, the controller 20 receives 3D part information. This step is similar to step S210 in operation S200, and details explained herein regarding step S210 are likewise applicable to step S605. As one example, the 3D part may be the part illustrated in FIGS. 3A and 7A, and the 3D part information may be part geometry information corresponding to such part.

In step S610, the controller 20 receives boundary condition information for the 3D part. Such boundary condition may include, for example, portions of the part which will be mounted and/or fixed and are not subject to displacement. It will be appreciated that the foregoing are merely examples, and any form of boundary conditions may be applicable towards the present invention. FIG. 7A illustrates example boundary condition(s) of the example part illustrated in FIGS. 3A and 7A, whereby the left hole of the part will be fixed. For example, this may occur if the hole is being used for mounting to another component (e.g., via a bolt and nut). The boundary condition(s) may influence the circumstances and applied forces upon which the 3D part is subject to deformation.

In step S615, the controller 20 generate a mesh of the part geometry corresponding to the 3D part, based on the 3D part information received in step S610. This step is similar to step S215 in operation S200, and details explained herein regarding step S215 are likewise applicable to step S615. As with step S215, the generated mesh may include, for example, a finite element mesh or a volumetric mesh. FIG. 3B illustrates an example part geometry mesh of the example part illustrated in FIGS. 3A and 7A.

In step S620, the controller 20 computes a stiffness matrix based on the mesh generated in step S615 and the boundary condition(s) received in step S610. This step is similar to step S220 in operation S200, except that the computed stiffness matrix takes into account the boundary condition(s) received in step S610. Nonetheless, details explained herein regarding step S220 are likewise applicable to step S620. Additionally, the controller 20 may compute the stiffness matrix based on the boundary condition information using an approach described in Cook, R. D., Malkus, D. S., & Plesha, M. E., CONCEPTS AND APPLICATIONS OF FINITE ELEMENT ANALYSIS (1989), which is incorporated by reference herein its entirety.

In step S625, the controller 20 computes eigenvectors and/or eigenvalues (e.g., collectively the “eigenmodes”) of the stiffness matrix computed in step S620. This step is similar to step S225 in operation S200, except that the stiffness matrix used for the computation takes into account the boundary condition(s). Nonetheless, details explained herein regarding step S225 are likewise applicable to step S625. As explained above, the computed eigenmodes may reveal information as to which portion of the 3D part is likely most susceptible to deformation. FIGS. 7B-7D illustrates examples of computed eigenmode shapes corresponding to the first example part illustrated in FIGS. 3A and 7A, as further subject to the boundary condition(s) illustrated in FIG. 7A.

In step S630, the controller 20 selects the eigenmode(s) corresponding to the lowest energy mode(s). This step is similar to step S230 in operation S200, and details explained herein regarding step S230 are likewise applicable to step S630.

In step S635, the controller 20 applies the selected eigenvector from step S630 to the 3D part geometry. This step is similar to step S235 in operation S200, and details explained herein regarding step S235 are likewise applicable to step S635.

In step S640, the controller 20 selects a first print setting of a set of 3D print settings. The set of 3D print settings may encompass the gamut of potential print settings that could be used in printing the 3D part. This step is similar to step S240 in operation S200, and details explained herein regarding step S240 are likewise applicable to step S640.

In step S645, the controller 20 computes an internal mechanical state of the 3D part having forced to deform to the fundamental deformation shape, in the circumstance where the print setting selected in step S640 is utilized. This step is similar to step S245 in operation S200, and details explained herein regarding step S245 are likewise applicable to step S645.

In step S650, the controller 20 determines whether there are additional print settings in the set of print settings. If there are additional print settings, the operation proceeds to step S655. If there are no more print settings, the operation proceeds to step S660. This step is similar to step S250 in operation S200, and details explained herein regarding step S250 are likewise applicable to step S650.

In S655, the operation advances to the next print setting in the set of 3D print settings. This step is similar to step S255 in operation S200, and details explained herein regarding step S255 are likewise applicable to step S655.

In step S660, the controller 20 determines and selects one or more optimal print settings from the set of print settings. It will be appreciated that various criteria may be employed to make such determination and selection. This step is similar to step S260 in operation S200, and details explained herein regarding step S260 are likewise applicable to step S660.

### Other Embodiments

Incorporation by reference is hereby made to U.S. Pat. Nos. 10,076,876, 9,149,988, 9,579,851, 9,694,544, 9,370,896, 9,539,762, 9,186,846, 10,000,011, 10,464,131, 9,186,848, 9,688,028, 9,815,268, 10,800,108, 10,814,558, 10,828,698, 10,953,609, U.S. Patent Application Publication No. 2016/0107379, U.S. Patent Application Publication No. 2019/0009472, U.S. Patent Application Publication No. 2020/0114422, U.S. Patent Application Publication No. 2020/0361155, U.S. Patent Application Publication No. 2020/0371509, and U.S. Provisional Patent Application No. 63/138,987 in their entireties.

Although this invention has been described with respect to certain specific exemplary embodiments, many additional modifications and variations will be apparent to those skilled in the art in light of this disclosure. For instance, while reference has been made to an X-Y Cartesian coordinate system, it will be appreciated that the aspects of the invention may be applicable to other coordinate system types (e.g., radial). It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof. rather than by the foregoing description.

What is claimed is:

1. An apparatus comprising:
at least one processor; and
at least one memory,
wherein the at least one memory stores computer-readable instructions which, when executed by the at least one processor, cause the processor to:
receive design data corresponding to an object;
compute, based on the received design data, stiffness information of the object;
determine a fundamental deformation shape, based on the stiffness information; and
determine a 3D print setting for printing the object, based on the determined fundamental deformation shape.

2. The apparatus of claim 1, wherein the determining of the fundamental deformation shape includes:
computing an eigenvector or eigenvalue based on the computed stiffness information;
determining at least one eigenvector or eigenvalue having a low energy mode; and
applying the determined at least one eigenvector or eigenvalue having a low energy mode to the received design data corresponding to the object.

3. The apparatus of claim 1, wherein the determining of the 3D print setting for printing the object includes:
computing, for each 3D print setting within a set of 3D print settings for printing the object, an internal mechanical state of the object, based on the determined fundamental deformation shape and the respective 3D print setting; and
determining one or more 3D print settings based on the computed internal mechanical states,
wherein the set of 3D print settings includes a plurality of 3D print setting options.

4. The apparatus of claim 3, wherein a 3D print setting within the set of 3D print settings includes an infill parameter.

5. The apparatus of claim 3, wherein a 3D print setting within the set of 3D print settings includes a fiber reinforcement parameter.

6. The apparatus of claim 3, wherein the computation of the internal mechanical state of the object includes using a finite element method.

7. The apparatus of claim 3, wherein the computation of the internal mechanical state of the object includes calculating an internal strain energy of the object.

8. The apparatus of claim 3, wherein the determination of the one or more 3D print settings based on the computed internal mechanical states includes determining a 3D print setting having the lowest simulated stress.

9. The apparatus of claim 1, wherein the computer-readable instructions, when executed by the at least one processor, cause the at least one processor to receive one or more boundary conditions corresponding to the object, and
wherein the stiffness information of the object is computed based on the received design data and the one or more boundary conditions.

10. The apparatus of claim 1, wherein the computer-readable instructions, when executed by the at least one processor, cause the at least one processor to control printing of the object in accordance with the determined one or more 3D print settings.

11. A method comprising:
receiving design data corresponding to an object;
computing, based on the received design data, stiffness information of the object;
determining a fundamental deformation shape, based on the stiffness information; and
determining a 3D print setting for printing the object, based on the determined fundamental deformation shape.

12. The method of claim 11, wherein the determining of the fundamental deformation shape includes:
computing an eigenvector or eigenvalue based on the computed stiffness information;
determining at least one eigenvector or eigenvalue having a low energy mode; and
applying the determined at least one eigenvector or eigenvalue having a low energy mode to the received design data corresponding to the object.

13. The method of claim 11, wherein the determining of the 3D print setting for printing the object includes:
computing, for each 3D print setting within a set of 3D print settings for printing the object, an internal mechanical state of the object, based on the determined fundamental deformation shape and the respective 3D print setting; and
determining one or more 3D print settings based on the computed internal mechanical states,
wherein the set of 3D print settings includes a plurality of 3D print setting options.

14. The method of claim 13, wherein a 3D print setting within the set of 3D print settings includes an infill parameter.

15. The method of claim 13, wherein a 3D print setting within the set of 3D print settings includes a fiber reinforcement parameter.

16. The method of claim 13, wherein the computation of the internal mechanical state of the object includes using a finite element method.

17. The method of claim 13, wherein the computation of the internal mechanical state of the object includes calculating an internal strain energy of the object.

18. The method of claim 13, wherein the determination of the one or more 3D print settings based on the computed internal mechanical states includes determining a 3D print setting having the lowest simulated stress.

19. The method of claim 11, wherein the computer-readable instructions, when executed by the at least one processor, cause the at least one processor to receive one or more boundary conditions corresponding to the object, and
wherein the stiffness information of the object is computed based on the received design data and the one or more boundary conditions.

20. The method of claim 11, wherein the computer-readable instructions, when executed by the at least one processor, cause the at least one processor to control printing of the object in accordance with the determined one or more 3D print settings.
